(19) United States
(12) Patent Application Publication
(10) Pub. No.: US 2026/0237170 A1
(43) Pub. Date: Aug. 13, 2026

(54) SYSTEM AND METHOD FOR CAPTURING BODY MEASURMENTS AND ASSOCIATING THE MEASURMENTS WITH A THREE-DIMENSIONAL AVATAR

(71) Applicant: Vinay Mahajan, New York, NY (US)

(72) Inventor: Vinay Mahajan, New York, NY (US)

(21) Appl. No.: 19/049,104

(22) Filed: Feb. 10, 2025

(51) Int. Cl. G06T 19/20; G06T 7/60; G06T 7/70; G06T 19/00; H04N 23/60

(52) U.S. Cl. CPC G06T 19/20; G06T 7/60; G06T 7/70; G06T 19/006; H04N 23/64; G06T 2200/24; G06T 2207/30196; G06T 2219/2004; G06T 2219/2016

(57) ABSTRACT

A method and system for capturing a plurality of body measurements of a User via an electronic mobile device equipped with a camera and generating a corresponding three-dimensional Avatar. The plurality of body measurements of a human can be captured by instructing a User to pose in a plurality of different positions while automatically enabling the electronic mobile device to capture each of the different poses associating the captured body measurements with a 3D generated Avatar representing the User, wherein the generated Avatar can be manipulated through a User interface screen of the mobile device to place the Avatar in any desired position and stored together with the captured multiple body measurements to be later shared with third parties for use in manufacturing items to specifically fit the User's body measurements.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to a system and method that is downloadable onto mobile devices, tablets, laptops, etc., to capture body poses, calculate a plurality of body measurements from the captured poses, and display the calculated body measurements on a generated three-dimensional (3D) Avatar. More particularly, but not exclusively, the present inventive concept relates to a set of Computer Vision proprietary algorithms based on automated voice commands that direct a User to assume a predetermined set of body poses, capture these body poses through a camera on the mobile device and calculate the User's body measurements (up to 16 body measurements for a female or 14 body measurements for a male), wherein each calculated body measurement can be displayed in a generated numerical table. Moreover, each of these calculated body measurements are then linked to a 3D generated Avatar that can be displayed and includes “digital bones” and “inverse kinematics” features, such that the User can tap any of the calculated body measurements in the table and view the precise location of this body measurement on the Avatar.

The Avatar is further configured to be manipulatable into any position through an icon displayed with the Avatar. This Avatar manipulation can be performed by moving the User's fingers over the displayed icon to have the Avatar assume various human-like poses. Also generated on the display are buttons to choose among for the purposes of exporting/sharing the results with third parties to communicate not only their body measurements in numerical tabular format but also their chosen body type and position in a visual format. Furthermore, an Augmented Reality camera feature built into the present inventive proprietary App can be used by the User to place, resize and manipulate this three-dimensional digital Avatar onto real world objects that are captured by this camera, which can then be communicated/exported/shared with third parties.

This generated 3D Avatar can be viewed through augmented reality, where the user can place the Avatar anywhere in space and then move around the Avatar at will. Each measurement can be displayed either by showing a line or by showing a circle on the Avatar. Through the App the user can change the position of each joint and therefore adjust the display of the measurement. The use cases of all these features are several including, but not limited to, custom designing clothes or furniture for a User, designing custom automobiles for a User, selling or buying homes or apartments for a specific User, custom designed fitness applications for a User to assume various calisthenics, gymnastic or yoga poses, etc. In other words, the present inventive concept enables Users to communicate how he/she wishes their body measurements to be used by a third party such as a furniture manufacturer, an automobile manufacturer suing CAD/CAM, Realtors to convey a User's dimensions, Garment manufacturers, fitness manufacturers, etc.

### 2. Description of the Related Art

Methods of obtaining three-dimensional measurements of a human body generally require Users to keep eye contact with a mobile device having a camera for recording the User's body, while positioning the User body to fit a certain specification displayed on the mobile device's display. Other three-dimensional methods for obtaining measurements of a human body require a User to rotate around a measuring device while the measuring device scans the User, while some of these types of measuring devices still further require a User to wear a body suit while their body is being scanned.

U.S. Pat. No. 11,062,508 by Moody discloses a process of creating a three-dimensional model of a customer by capturing images of the customer. Here the customer stands still while several images are captured. As a result, an actual three-dimensional model of the customer is very limited regarding accuracy of the customer's body shape and body measurements. This three-dimensional model is used to extract parameters representing the customer's body profile and are used to form a “customer or client vector describing the customer's body shape.” (See Column 4, lines 45-51). There are no instructions provided for a customer to stand at different poses to capture accurate views of the customer's body and then to calculate a plurality of body measurement values. Further, there is no ability to rotate and manipulate an Avatar of the customer in order to provide body measurements for designing different items for the customer.

US Patent Publication Number US 2015/0154453 by Wilf discloses a method of obtaining body size measurements of a user from 2D images captured of the user, including guiding the use through a sequence of poses, and then integrating the 2D shape images into a 3D shape model.

Other three-dimensional methods of obtaining dimensions of the human body require large and/or expensive sensors, such as stereo imaging devices, three-dimensional scanners, depth sensing devices, etc.

Accordingly, there is a need for a computer-generated User interface (GUI) input parameter that requires a height of a User to determine the scale of the USER'S body using two-dimensional (2D) photographic images. Therefore, there is a need for a process to determine the User's precise height using computer generated text-to-voice commands that guides the User to strategically place a camera equipped mobile device on a surface on which the User is standing, raise the mobile device up to the User's eye level, and then hold the device stationary for approximately five seconds, which allows the present inventive concept to automatically record the User's actual height. The present inventive concept also uses a proprietary calculation to adjust for a difference between the User's eye level and the top of the User's head in order to obtain an accurate overall height of the User.

There is also a need for a process of obtaining three-dimensional (3D) measurements of a User's (human) body which provides text-to-voice audio instructions to autonomously guide a User to position the User's body at different poses with respect to a fixed position of a camera equipped mobile device until a required number of poses are captured with the camera, and also to notify the User, via audio, when a detected pose by the User is incorrect.

There is also a need for a process of capturing two-dimensional (2D) measurements of a human body (aka: body poses) and use the captured poses to calculate up to sixteen different body measurements of a User's body.

There is also a need for a process that can overlay two-dimensional (2D) photographic images captured from human body poses onto a computer vision program that can automatically detect the User's neck, wrist, shoulder, pelvic, knee and ankle joints of the User's body.

There is also a need for a process that can compute the angles between the detected joints of a User's body and compare these calculated angles to specifically required angles of a set of body poses in order to detect whether the captured body poses are correctly captured.

There is also a need for a process that can use computer vision artificial intelligence technology (AI) to notify the User via text-to-voice audio instructions when an angle of any of the joints detected is outside an error tolerance.

Additional provisions of the present inventive concept can be ascertained from the detailed description provided herein.

### SUMMARY OF THE PRESENT INVENTIVE CONCEPT

The present general inventive concept provides a system and process that is downloadable onto mobile devices, tablets, laptops, etc., to capture body poses, calculate a plurality of body measurements from the captured poses, and display the calculated body measurements on a generated three-dimensional (3D) Avatar. More particularly, but not exclusively, the present inventive concept relates to a set of Computer Vision proprietary algorithms based on automated voice commands that direct a User to assume a predetermined set of body poses, capture these body poses through a camera on the mobile device and calculate the User's body measurements (up to 16 body measurements for a female or 14 body measurements for a male), wherein each calculated body measurement can be displayed in a generated numerical table. Moreover, each of these calculated body measurements are then linked to a 3D generated Avatar that can be displayed and includes “digital bones” and “inverse kinematics” features, such that the User can tap any of the calculated body measurements in the table and view the precise location of this body measurement on the Avatar. The Avatar is further configured to be manipulatable into any position through an icon displayed with the Avatar. This Avatar manipulation can be performed by moving the User's fingers over the displayed icon to have the Avatar assume various human-like poses. Also generated on the display are buttons to choose among for the purposes of exporting/sharing the results with third parties to communicate not only their body measurements in numerical tabular format but also their chosen body type and position in a visual format. Furthermore, an Augmented Reality camera built into the present inventive proprietary App can be used by the User to place, resize and manipulate this three-dimensional digital avatar on to real world objects that are captured by this camera, which can then be communicated/exported/shared with third parties. The use cases of all these features are several including, but not limited to, custom designing cloths or furniture for a User, designing custom automobiles for a User, selling or buying homes or apartments for a specific User, custom designed fitness applications for a User to assume various calisthenics, gymnastic or yoga poses, etc. In other words, the present inventive concept enables Users to communicate how he/she wishes their body measurements to be used by a third party such as a furniture manufacturer, an automobile manufacturer suing CAD/CAM, Realtors to convey a User's dimensions, Garment manufacturers, fitness manufacturers, etc.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a computer implemented process configured to calculate a plurality of body measurement values of a User and display a specifically generated Avatar with a plurality of human body measurements regions with the body measurement values linked thereto, the process comprising: downloading and executing a specifically configured computer vision AI technology program onto a mobile device; automatically instructing a User through audio to enter personal credentials; automatically instructing the User through audio to position the smart mobile device on the ground to capture six different body poses of the User; automatically capturing a 2D photograph of each of the six different body poses of the User; automatically detecting potential errors in any of the six captured body poses by comparing the each of the six captured body poses with six stored pre-configured body pose positions; instructing the User to how to correct detected errors in body poses by guiding the User how to pose to capture corrected erroneous body poses; calculating at least fourteen different body measurement values of the User; storing the calculated body measurement values with a date and time stamp to create a historical record for the User; generating and displaying a table of the at least fourteen different body measurement regions together with corresponding calculated body region measurement values on a display of the mobile device to be selected; and displaying a 3D avatar on the display of the mobile device together with an indicator of the location on the avatar of a selected one of the at least fourteen body measurement values from the table together with the selected body region measurement value.

In an exemplary embodiment, the personal credentials instructed to be entered include gender and height.

In another exemplary embodiment, the step of automatically instructing the User to position the smart mobile device on the ground to capture six different body poses of the User includes audio instructions providing sequential audio instructions to pose in one of six different positions, each sequential audio instruction being provided after a photograph is automatically captured of a current pose.

In another exemplary embodiment, errors in each of the six captured body poses are detected when the comparison between each of the captured body poses and each of the six stored pre-configured body pose positions is outside a preset error tolerance range.

In still another exemplary embodiment, the computer vision AI technology program will activate text-to-voice audio commands directing the User as to which limb(s) of the body to adjust in order to guide the User to assume the correct angle between the joints and then capture a corrected body pose.

In yet another exemplary embodiment, an interactive icon is displayed on the avatar which enables a User to rotate and/or reposition the avatar in various different positions while the indicator of the location on the avatar of a selected one of the at least fourteen body measurements together with the selected body region measurement value is displayed.

In still another exemplary embodiment, the process further comprises displaying an icon that enables the User to export the avatar together with the table of the at least fourteen different body measurement regions together with the corresponding calculated body region measurements.

In yet another exemplary embodiment, the avatar and table of the at least fourteen different body measurement regions together with the corresponding calculated body region measurements can be exported through a displayed option button via email, printing, or a messaging app.

In still another exemplary embodiment, the at least fourteen different body measurements calculated includes fourteen different body measurements for a male gender input and sixteen different body measurements for female gender input.

The foregoing and/or other features and utilities of the present general inventive concept may also be achieved by providing a system, comprising: one or more computer processors; a non-transitory computer-readable memory storing red specifically configured computer vision AI technology program that, when executed by the one of more processors, cause the system to: display a User interface screen; automatically instruct a User through audio to enter personal credentials into a generated input prompt; automatically instruct the User through audio to position a smart mobile device, on which the computer-readable instructions are downloaded thereon, on the ground to capture six different body poses of the User; automatically capture a 2D photograph of each of the six different body poses of the User; automatically detect potential errors in any of the six captured body poses by comparing each of the six captured body poses with six stored pre-configured body pose positions; instruct the User through audio how to correct detected errors in body poses by guiding the User to re-pose in a corresponding one of the pre-configured body poses to capture a corrected body pose; calculate at least fourteen different body measurements of the User using the six captured body poses; storing the calculated body measurements with a date and time stamp to create a historical record for the User; generate and display a table of the at least fourteen different body measurement regions together with corresponding calculated body region measurements on a display of the mobile device to be selected; and display a 3D avatar on the mobile device display together with an indicator of the location on the avatar of a selected one of the at least fourteen body measurements from the table together with the selected body region measurement value.

In an exemplary embodiment, the personal credentials to be entered into the input prompt include gender, and height of the User.

In another exemplary embodiment, the automatic instructions for the User to position the smart mobile device on the ground to capture six different body poses includes sequential audio instructions to pose in one of six different positions, each sequential audio instruction being provided after a photograph is automatically captured of a current pose.

In another exemplary embodiment, errors in each of the six captured body poses are detected when the comparison between each of the captured body poses and each of the six stored pre-configured body pose positions is determined to be outside a preset error tolerance range.

In still an exemplary embodiment, the computer vision AI technology program will activate text-to-voice audio commands instructing the User as to which limb of the body to adjust in order to guide the User to the correct angle between the joints and then capture a corrected body pose.

In yet an exemplary embodiment, an interactive icon is displayed on the avatar which enables a User to rotate and reposition the avatar in various different positions while the indicator of the selected location on the avatar among the at least fourteen body measurements together with the selected body region measurement value is displayed.

In yet an exemplary embodiment, the computer program further displays an icon that enables the User to export the avatar together with the table of the at least fourteen different body measurement regions together with the corresponding calculated body region measurements.

In still an exemplary embodiment, the computer-readable program generates an icon that enables the User to export the avatar and table of the at least fourteen different body measurement regions together with the corresponding calculated body region measurements via email, print and message via a messaging app.

In still an exemplary embodiment, the at least fourteen different body measurements calculated include fourteen different body measurements for a male gender input and sixteen different body measurements for female gender input.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a first setup stage of a process of obtaining body measurements, according to an example embodiment of the present inventive concept.

FIG. 2A illustrates a second stage of the process of obtaining body measurements, according to an example embodiment of the present inventive concept.

FIG. 2B illustrates a third stage of the process of obtaining body measurements, according to an example embodiment of the present inventive concept.

FIG. 2C illustrates a process of selecting a type of version of the process of obtaining body measurements, according to an example embodiment of the present inventive concept.

FIG. 2D illustrates a third stage of the process of obtaining body measurements, according to an example embodiment of the present inventive concept.

FIG. 3A illustrates a User interface providing a set of instructions to prepare a User for obtaining body measurements according to an example embodiment of the present inventive concept.

FIG. 3B illustrates a User interface which illustrates captured body measurements according to an example embodiment of the present inventive concept.

FIG. 3C illustrates a User interface displaying an example of a table of body parts and obtained body measurements of the body parts, according to an example embodiment of the present inventive concept.

FIG. 3D illustrates a User interface displaying an Avatar and selected body part of the Avatar in response to a selected one of the body measurements illustrated in FIG. 3C.

FIG. 3E illustrates a User interface displaying a selected position and shape of a generated Avatar of the User according to an example embodiment of the present inventive concept.

FIG. 3F illustrates a User interface displaying options of body types to select from according to an example embodiment of the present inventive concept.

FIG. 4 illustrates a process of obtaining body measurements, according to another example embodiment of the present inventive concept.

The drawings illustrate a few example embodiments of the present inventive concept and are not to be considered limiting in its scope, as the overall inventive concept may admit to other equally effective embodiments. The features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements or steps, modify the entire list of elements or steps and do not modify the individual elements or steps of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Hereinafter, one or more exemplary embodiments of the present general inventive concept will be described in detail with reference to the accompanying drawings.

Example embodiments of the present general inventive concept are directed to an application, system and method for obtaining multiple body measurements at different angles to be displayed on a three-dimensional Avatar representing a corresponding body type, which can then be exported to third parties for multiple uses, such as, for example designing clothes, using the avatars for designing furniture, for designing automobiles, for selling homes/apartments, for fitness applications, for presenting gymnastic or yoga poses, etc.

Any reference in the specification to a method should be applied mutatis mutandis to a system capable of executing the method and should be applied mutatis mutandis to a computer readable medium that is non-transitory and stores process steps of the proprietary App for executing the method.

Any reference in the specification to a system should be applied mutatis mutandis to a method that may be executed by the system and to a computer program that stores instructions for executing the method.

Any reference in the specification to a computer program product should be applied mutatis mutandis to a method that is performed when executing instructions stored in the computer program product and to a system that is configured to execute the instructions stored in the computer program. The computer program product is non-transitory and may include a non-transitory medium for storing instructions. Non-limiting examples of the computer program product include a memory chip, an integrated circuit, a disk, and a magnetic memory unit.

As described in greater detail below, implementations of the present inventive concept are directed to a proprietary software application (the proprietary App), executable on an electronic mobile device, which is configured to obtain multiple measurements of a human (hereinafter referred to as the “User”). More specifically, the proprietary App is configured to provide audio instructions to the User to stand in six different poses while a camera(s) of the electronic mobile device is operated by the proprietary App to capture a photograph of each of the different poses and then calculate a plurality of body measurement values of the User from the captured poses. These calculated body measurement values can then be placed in a generated table and also linked to a generated three-dimensional (3D) Avatar. The three-dimensional (3D) Avatar is generated based on personal data obtained with respect to the User (input by the User at an input prompt).

As described in more detail below, the generated three-dimensional (3D) Avatar can be manipulated and moved to multiple different positions on a User interface displayed on a display of the electronic mobile device and then stored in the different positions. According to an example embodiment of the present inventive concept, sixteen body measurement values can be obtained for a woman and fourteen body measurement values can be obtained for a man. The number of body measurement values calculated can depend on the gender input by the User. However, the number of measurements to be obtained by the proprietary software application described herein can be configured to obtain a different number of body measurements as may be desired, without departing from the overall spirit and scope of the overall present inventive concept.

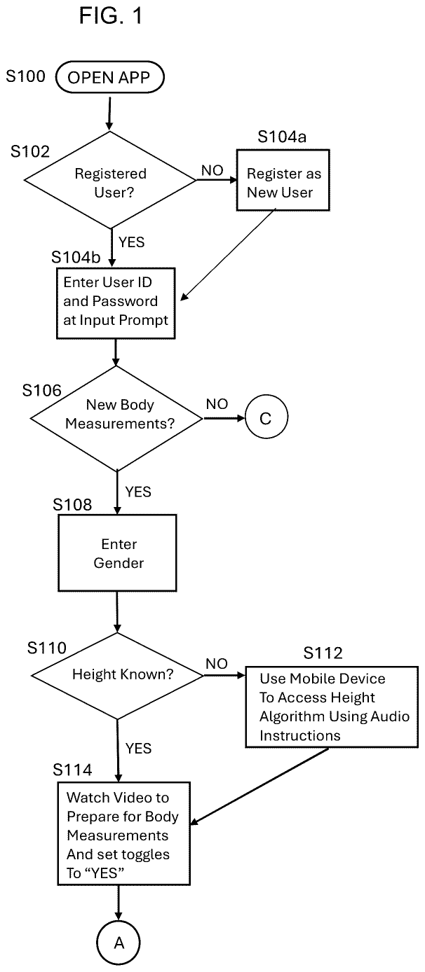

FIG. 1 illustrates a first “setup” stage of a process configured in the proprietary application (hereinafter referred to as “the proprietary App” or “App”) of the present inventive concept for obtaining body measurement values. Referring to FIG. 1, a User of an electronic mobile device (i.e., a mobile phone, tablet, Ipad®, laptop, etc.) first downloads and executes the proprietary App in which the present inventive concept is configured therein, in order to perform the body measurement process according to the present inventive concept. Once the proprietary App of the present inventive concept is executed at Step S100 (S100) a graphic User interface (GUI) is generated and displayed on a display of the electronic mobile device. This GUI provides an input prompt requesting an input by the User as to whether the User is registered with the App (S102). If the User selects an option “NO” on the User interface the GUI of the App displays an input prompt enabling the User to enter necessary credentials to register (S104a). Once the User registers with the App the GUI presents another input prompt requesting the registered User to enter a User ID and Password (S104b). However, if the User of the App has previously registered then the User will select an option “YES” (S102). Once the User selects “YES” the GUI of the App will display a prompt requesting the registered User to enter his/her User ID and Password (S104b).

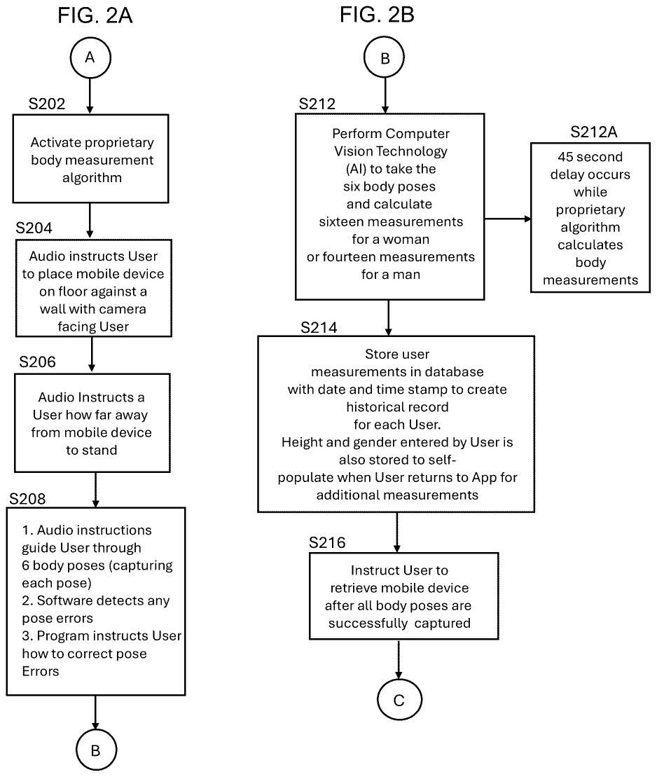

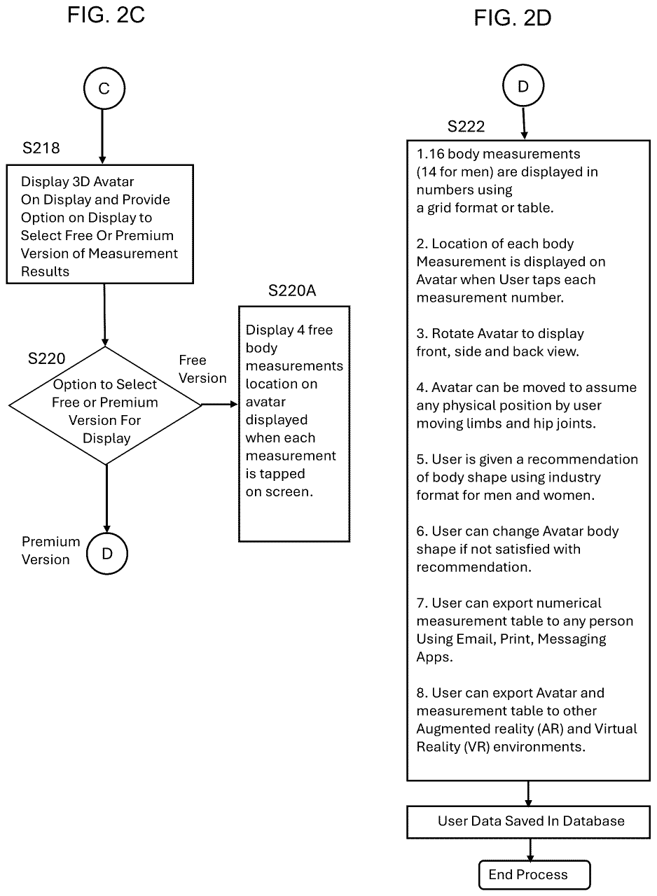

Once the User has entered a User ID and Password the GUI displays an input prompt requesting an input as to whether new body measurements are desired to be obtained (S106). If the User selects an option “NO” then the App directs the User to a process “C” described in more detail below. However, if the User selects an option “YES” an input prompt is displayed (S108) which requests the User to enter a his/her gender. After the gender of the User is entered an interface prompt is displayed (S110) requesting whether the User's height is known. If the User selects the prompt “NO” the proprietary App transitions to an algorithm which provides audio instructions to the User as to what to do in order to obtain the User's exact height (S112). More specifically, in accordance with an example embodiment the proprietary App can instruct the User via text-to-voice commands, generated by an algorithm of the present inventive concept, to move the camera of the electronic mobile device from the ground surface on which the User is standing up to the User's eye level and then hold the mobile device stationary for approximately five seconds (this time can vary depending on the capability of the calculation program), which will allow the algorithm to automatically calculate and record the User's height. The algorithm is further configured to then use a proprietary calculation to calculate an adjusted measurement to the top of the User's head in order to adjust for the difference between the User's eye level and the top of the User's head so as to obtain an accurate height of the User from head to feet. However, if the User knows his/her height the User can select the prompt “YES” at S110, which will result in a User interface being generated which provides a video instructing the User what to do in order to obtain body measurement values (S114). After the instructional video is completed the GUI then enables the User to select a prompt labeled “YES” to begin the process “A” of obtaining body measurement values (S114), which is described in more detail below with reference to FIG. 2A.

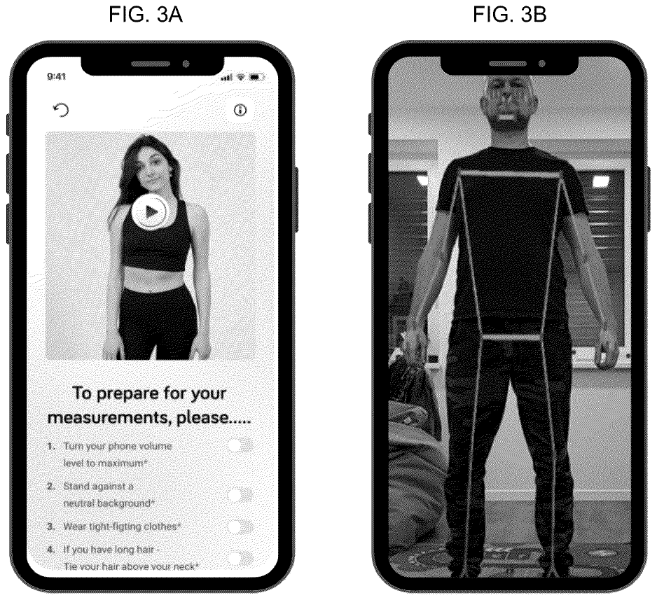

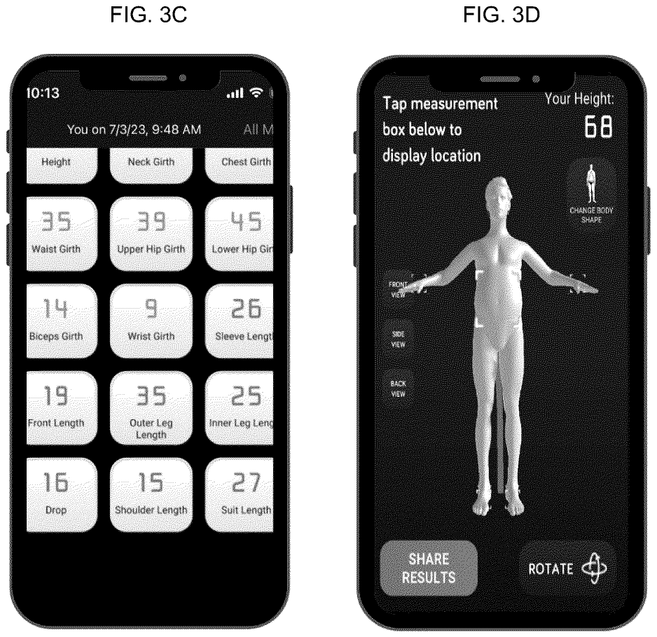

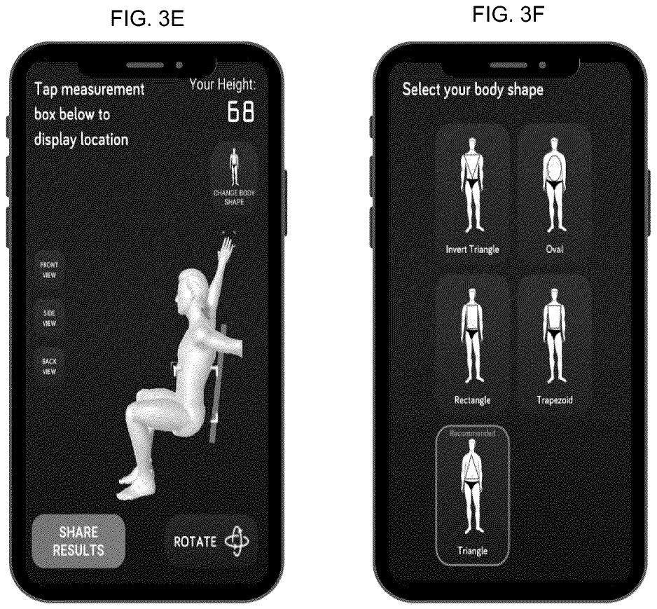

FIG. 2A illustrates a second stage of the process configured in the proprietary App of the present inventive concept for obtaining body measurement values. Referring to FIG. 2A, after a User selects the prompt “YES” in Step S114 an algorithm for obtaining body measurement values is executed by the proprietary App at Step (S202). The proprietary App will also generate a GUI with a set of instructions to be followed to begin the process of obtaining body measurement values. An example embodiment of the GUI is illustrated in FIG. 3A.

FIG. 3A illustrates an example embodiment of a GUI with instructions to be followed by the User to begin the process of obtaining body measurement values. As illustrated in FIG. 3A, the GUI can include the following instructions: 1) “Turn your phone volume level to maximum”; 2) “Stand against a neutral background”; 3) “Wear tight fitting cloths”; and 4) “If you have long hair tie your hair above your neck.” Adjacent to each of the instructions listed on the GUI, as pointed out above, can be a toggle switch that can be turned on by simply touching it to acknowledge that each of the instructions have been performed, thus activating the body measurements feature. It is to be noted that other instructions may be provided without departing from the spirit and scope of the overall present inventive concept.

Once each of the toggle switches are switched to the enabled position the body measurements feature of the proprietary App will provide text-to-voice audio instructions to place the electronic mobile device on the floor against a wall with the camera facing the User at Step S204. The proprietary App will then recognize the User via the camera and provide text-to-voice instructions for the User to move to a certain distance from the electronic mobile device at Step 206. Upon detection of the correct position of the User the proprietary App will then provide text-to-voice audio instructions to autonomously guide the User through six body poses while capturing an image of each of the six poses at Step S208. More specifically, audio instructions will be provided for each pose position to be taken, and each pose will be captured and recorded at the completion of a countdown of a predetermined number of seconds, for example five seconds (5, 4, 3, 2, 1). Further, when each pose is captured by the camera of the electronic mobile device the proprietary App can generate an audio sound of a camera clicking to indicate that the corresponding pose has been captured. Each captured pose is recorded in the proprietary App software in a server database (not illustrated). It is to be noted that less or more than six body poses can be requested and captured, without departing from the spirit and scope of the overall present inventive concept.

A proprietary algorithm of the present inventive concept will overlay these two-dimensional (2D) photographic images on to a computer vision program that automatically detects the neck, wrist, shoulder, pelvic, knee and ankle joints of the User's body, as is described in more detail below. Another proprietary algorithm of the present inventive concept will compute the angles between these joints and compare them to specific angles that each of the six programmed body poses require in order to determine that each body pose has been properly obtained.

Once all the poses have been captured this proprietary algorithm then uses computer vision artificial intelligence technology (AI) to notify the User, via text-to-voice audio instructions, when an angle of any joint is detected to be outside an error tolerance. This step can be performed for each of the six body poses in serial order. Alternatively, the proprietary App can detect an erroneous pose directly after each pose is captured. If any of the captured poses are detected to be in error the proprietary App will instruct the User how to correct each erroneous pose detected. More specifically, the proprietary App includes a voice guidance feature that detects errors in the physical positions of the User. Each of the six poses includes a list of “angles” between the User's joints in which an embedded computer vision AI technology program detects. This embedded computer vision AI technology program will compare programmed angles in which a User is supposed to assume (programmed angles in the proprietary App) with angles in which a User actually assumes (angles detected), with a predetermined amount of error tolerance. If the difference in the angles programmed as compared to the angles detected is outside the error tolerance the computer vision AI technology program will activate text-to-voice audio commands directing the User as to which limb(s) of the body needs to be adjusted in order to guide the User to assume the correct angle between the joints for the corresponding pose. A few examples of algorithms that can be used to perform this feature are “BlazePose” and “Mediapipe.” More specifically, the App can send User images from the camera to “BlazePose,” which will return a list of all detected body joints to make the comparison. One of the novel features of the present inventive concept is the process of synthesizing the proprietary pose detection software with the open source software by BlazePose. Once each of the six poses have been successfully captured the computer vision AI technology program will activate an additional calculation algorithm to calculate multiple body measurements, as described below with reference to FIG. 2B.

FIG. 2B illustrates a third stage of the process of obtaining body measurements, according to an example embodiment of the present inventive concept. Referring to FIG. 2B, the proprietary App will perform the third stage of the process of the proprietary App for obtaining body measurements by calculating sixteen body measurements for a female User and fourteen body measurements for a male User, based on the gender input by the User at Step S108, by using a programed algorithm within the computer vision AI technology program at Step S212, and will also display these sixteen (or fourteen) body measurements on a User interface as illustrated in FIG. 3B. More specifically, FIG. 3B illustrates a User interface display where locations along the User's body extremities where body measurements have been calculated. These calculated measurements can include, for example: 1. Neck girth; 2. Chest girth; 3. Waist girth; 4. Upper hip girth (belt line); 5. Lower hip girth (buttocks); 6. Bicep girth; 7. Wrist girth; 8. Sleeve length (base of neck to wrist); 9. Shirt length (back of neck to upper hip); 10. Inner leg length; 11. Outer leg length; 12. Suit length (calculated from User's back pose-starting from base of neck to buttocks); 13. Shoulder width (calculated from User's back pose-horizontal distance between two should joints); 14. Drop (distance from upper hip where User ties their belt to User's crotch). In the case where a woman is obtaining body measurements, two additional calculations are: 15. Shoulder to nipple and 16. Nipple to upper chest. It is to be noted that the calculated body measurements are not limited to the above listed locations and can be revised to other locations of a human's body without departing from the spirit and scope of the overall present inventive concept.

Once each of the fourteen body measurements for a man (or sixteen for women) have been calculated (there may be wait period delay time while the calculations are being completed (see S212A)) all of these calculations are stored in a database with a date and time stamp to create a historical record for each User at Step S214. The User's height and gender are also stored in the database in order to self-populate all stored data at a later time when the User returns to the proprietary App for additional body measurements. Once all body measurements are calculated and stored in memory the proprietary App will instruct the User to retrieve the electronic mobile device at Step S216 and display an Avatar on the electronic mobile device display, as described in more detail below with reference to FIG. 2C.

FIG. 2C illustrates a process of selecting a type of version of the proprietary App desired for presenting the calculated body measurements, according to an example embodiment of the present inventive concept. Referring to FIG. 2C, after the proprietary App instructs the User to retrieve the electronic mobile device from the position where the body poses are captured the proprietary App will display a three-dimensional Avatar with an option to select from either a “FREE” or “PREMIUM” version of the body measurement results depending on number of body measurements the User would like to view at Step S218. If the User selects the FREE version of the body measurement results the proprietary App will display four body measurements at Step S220A in a numerical Table (not illustrated but similar to the Table illustrated in FIG. 3C for the PREMIUM version described below). This numerical Table is linked to the three-dimensional Avatar which will be displayed when the User taps/touches one of the body measurements provided in the Table displayed to illustrate where this body measurement is located on the Avatar. This three-dimensional Avatar is generated to be a representation of the User's body and can be based on information obtained during steps S108-S114 and S208-S212.

This generated 3D Avatar can be viewed on the User's mobile device, where the user can use his/her finger to place the Avatar anywhere in space and then move around the Avatar at will. Each body measurement can be displayed either by showing a line or by showing a circle on the Avatar. Through the App the user can change the position of each joint of the Avatar on the mobile device screen and therefore adjust the display of the measurement.

Alternatively, if the User selects the PREMIUM version of the body measurement results the proprietary App will display fourteen body measurements for a man (or sixteen for a woman) on a numerical Table, as described in FIG. 2D at Step S222 and illustrated in FIG. 3C. Here the numerical table illustrated in FIG. 3C will show all fourteen (or sixteen for women) of the calculated body measurements. Each body measurement provided in the Table illustrated in FIG. 3C can be tapped by the User to cause the proprietary App to show where this body measurement is located on the generated three-dimensional Avatar, as illustrated in FIG. 3D. For example, if the User taps the body measurement description labeled “Inner Leg Length” (see FIG. 3C) the proprietary App will display the three-dimensional Avatar together with an indicator mark showing where the “Inner Leg Length” is located (see vertical line between Avatar's legs, FIG. 3D), as well as indicating the actual body measurement value, which is illustrated in FIG. 3C as being 25 inches in length for this particular User.

Also as illustrated in FIG. 3D, the three-dimensional Avatar can be rotated by touching the mobile device display with a finger (within the four corners of an illustrated box) and moving the finger back and forth across the display. For example, the Avatar can be rotated by moving a finger across the display from left to right or from right to left after placing the finger within the illustrated four corners representing a box (see four corners indicated in white). It is to be noted that alternative equivalent interactive features can be provided for indicating where a User's finger can be placed to rotate the Avatar to a desired position and to actively rotate the Avatar.

FIG. 3E illustrates a User interface displaying a selected position and shape of a generated Avatar representing the User, according to an example embodiment of the present inventive concept. Referring to FIG. 3E, the three-dimensional Avatar can also be moved to multiple different positions by placing a finger within the four corners representing a box and then moving the finger to the desired position for the Avatar, such as a position where the Avatar is sitting down (as illustrated in FIG. 3E) for purposes of positioning the Avatar to be used to have specifically designed furniture made to fit the User. The selected position can be manipulated to illustrate different views thereof, such as displaying a front view, a side view and a back view by touching the corresponding icons “front view,” “side view” and “back view” displayed on the left side of the presently displayed User interface. Once the body type measurements and desired Avatar position is selected by the User and stored in the database these measurements and Avatar position(s) can be shared with a third party, such as a tailor for clothing design, a furniture designer, etc., by selecting a “SHARE RESULTS” icon displayed at the bottom left side of the User interface illustrated in FIG. 3E.

The PREMIUM version of the App also provides other features, such as, for example, providing a recommendation of the User's body type based on the body measurements calculated, as well as providing a selection of alternative body types for the User to choose from, as illustrated in FIG. 3F. More specifically, the display generated by the proprietary App of the present inventive concept as illustrated in FIG. 3F can provide several different versions of an Avatar to choose from with respect to different body types in which a User feels more accurately represents his/her actual body type. Different shapes of torsos are disposed on each body type illustrated for a User to select from in order to more accurately depict what a User feels is his/her true body type.

Furthermore, the present inventive proprietary App is also configured to generate and display an Augmented Reality camera to place, resize and manipulate the generated 3D digital avatar on to real world objects that are captured by this camera, which can then be communicated/exported/shared with third parties. The use cases of all these features are several including, but not limited to, custom designing cloths or furniture for a User, designing custom automobiles for a User, selling or buying homes or apartments for a specific User, custom designed fitness applications for a User to assume various calisthenics, gymnastic or yoga poses, etc. In other words, the present inventive concept enables Users to communicate how he/she wishes their body measurements to be used by a third party such as a furniture manufacturer, an automobile manufacturer suing CAD/CAM, Realtors to convey a User's dimensions, Garment manufacturers, fitness manufacturers, etc.

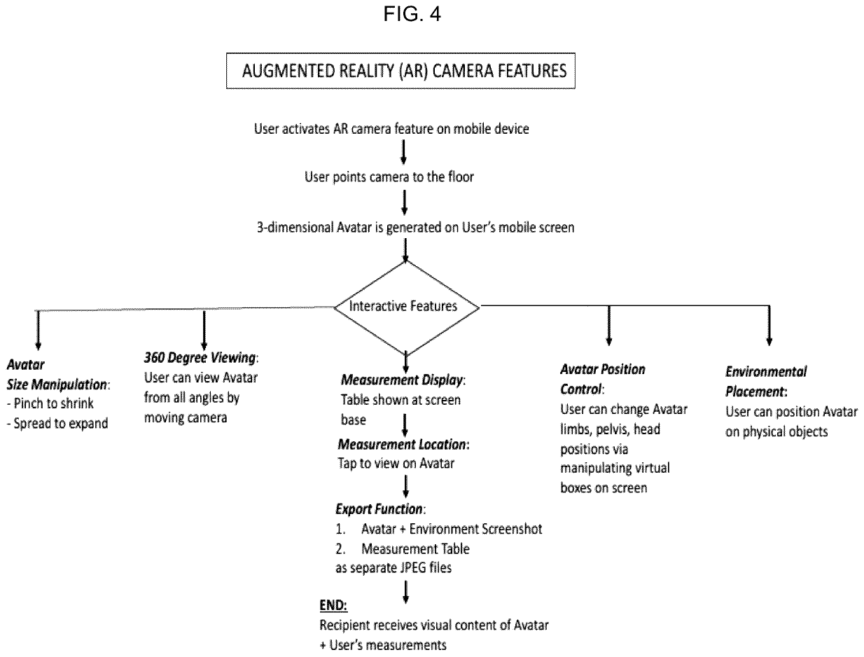

FIG. 4 illustrates a process of obtaining body measurements, according to another example embodiment of the present inventive concept. Referring to FIG. 4, a user can choose to activate the augmented reality (AR) camera feature via a mobile device. The user will then be directed to point the camera of the mobile device to the floor to generate a three-dimensional Avatar. When the Avatar appears on the User's mobile screen, the User can manipulate the Avatar in the following ways:
a. Change the size of Avatar: tapping the mobile screen to reduce the Avatar size by pinching the screen with his/her fingers or expand the size by moving the fingers apart;
b. View the Avatar from 360 degrees by the User moving around the Avatar with his/her mobile camera;
c. Move the limbs, pelvis and head of the Avatar by moving their fingers on virtual boxes displayed on their mobile screen to achieve any human position such sitting, touching toes, bending backwards, lying prone to replicate a sleeping position, etc.;
d. Place the Avatar on any physical object in User's environment by manipulating the Avatar on the mobile screen and adjusting its limbs, pelvis and spine to adapt to the shape of the physical object;
e. A measurement table that displays the User's body measurements is displayed at the base of the mobile screen
f. The User can tap on any measurement in the measurement table and the physical location of that measurement is displayed on the Avatar; and
g. Export the screenshot of the User's actual environment along with the Avatar's location in that environment to a third party as a JPEG file. The measurement table will automatically accompany this exported file as a separate JPEG file. The combination of these two files will enable the recipient to understand how the User wishes to be envisioned in his/her environment using the Avatar's location as a proxy and what the User's physical measurements are to scale the physical environment.

The present general inventive concept can be embodied as specifically programmed computer-readable codes stored on a non-transient computer-readable medium. The non-transient computer-readable medium can include a computer-readable recording medium and a computer-readable transmission medium. The computer-readable recording medium can be any data storage device that stores data as a program which can be thereafter read and executed by a specifically configured computer system that can perform the processes programmed to be performed. Examples of the computer-readable recording medium include a semiconductor memory, a read-only memory (ROM), a random-access memory (RAM), a USB memory, a memory card, a blue-ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet).

The above-described contents are merely preferred embodiments of the present inventive concept and are not used to limit the present inventive concept. Any modifications, equivalent replacements, improvements, etc., made within the range of the spirit, principal and scope of the present inventive concept should be included in the scope of protection of the present inventive concept.

What is claimed is:

1. A computer implemented process downloadable onto a mobile device and configured to calculate a plurality of body measurement values of a User and display a specifically generated Avatar with a plurality of human body measurements regions with the body measurement values linked thereto, the process comprising:
executing a specifically configured computer vision AI technology program onto a mobile device;
automatically instructing a User through audio to enter personal credentials into a displayed input prompt;
automatically instructing the User through audio to position the smart mobile device on the ground to capture six different body poses of the User;
automatically capturing a 2D photograph of each of the six different body poses of the User;
automatically detecting potential errors in any of the six captured body poses by comparing the each of the six captured body poses with six stored pre-configured body pose positions;
instructing the User to how to correct detected errors in body poses by guiding the User how to pose to capture corrected erroneous body poses;
calculating at least fourteen different body measurements of the User;
storing the calculated body measurements with a date and time stamp to create a historical record for the User;
generating and displaying a table of the at least fourteen different body measurement regions together with corresponding calculated body region measurements on a display of the mobile device to be selected; and
displaying a 3D avatar on the display of the mobile device together with an indicator of the location on the avatar of a selected one of the at least fourteen body measurements from the table together with the selected body region measurement value.

2. The process according to claim 1, wherein the personal credentials instructed to be entered include a gender and a height of the User.

3. The process according to claim 1, wherein the automatically instructing the User to position the smart mobile device on the ground to capture six different body poses of the User includes audio instructions providing sequential audio instructions to pose in one of six different positions, each sequential audio instruction being provided after a photograph is automatically captured of a current pose.

4. The process according to claim 1, wherein errors in each of the six captured body poses are detected when the comparison between each of the captured body poses and each of the six stored pre-configured body pose positions is outside a preset error tolerance range.

5. The process according to claim 4, wherein the computer vision AI technology program will activate text-to-voice audio commands directing the User as to which limb(s) of the body to adjust in order to guide the User to assume the correct angle between the joints and then capture a corrected body pose.

6. The process according to claim 1, wherein an interactive icon is displayed on the avatar which enables a User to rotate and/or reposition the avatar in various different positions while the indicator of the location on the avatar of a selected one of the at least fourteen body measurements together with the selected body region measurement value is displayed.

7. The process according to claim 5, further comprising:
displaying an icon that enables the User to export the avatar together with the table of the at least fourteen different body measurement regions together with the corresponding calculated body region measurements.

8. The process according to claim 7, wherein the avatar and table of the at least fourteen different body measurement regions together with the corresponding calculated body region measurements can be exported via email, printing, or a messaging app.

9. The process according to claim 2, wherein the at least fourteen different body measurements calculated includes fourteen different body measurements for a male gender input and sixteen different body measurements for female gender input.

10. The process according to claim 1, wherein the generated avatar is configured to be viewed through augmented reality, where a user:
can place the avatar anywhere in space and move around the avatar; and
change the position of each joint of the avatar.

11. A system, comprising:
one or more computer processors;
a non-transitory computer-readable memory storing red specifically configured computer vision AI technology program that, when executed by the one of more processors, cause the system to:
display a User interface screen;
automatically instruct a User through audio to enter personal credentials into a generated input prompt;
automatically instruct the User through audio to position a smart mobile device, on which the computer-readable instructions are downloaded thereon, on the ground to capture six different body poses of the User;
automatically capture a 2D photograph of each of the six different body poses of the User;
automatically detect potential errors in any of the six captured body poses by comparing each of the six captured body poses with six stored pre-configured body pose positions;
instruct the User through audio how to correct detected errors in body poses by guiding the User to re-pose in a corresponding one of the pre-configured body poses to capture a corrected body pose;
calculate at least fourteen different body measurements of the User using the six captured body poses;
storing the calculated body measurements with a date and time stamp to create a historical record for the User;
generate and display a table of the at least fourteen different body measurement regions together with corresponding calculated body region measurements on a display of the mobile device to be selected; and
display a 3D avatar on the mobile device display together with an indicator of the location on the avatar of a selected one of the at least fourteen body measurements from the table together with the selected body region measurement value.

12. The system according to claim 11, wherein the personal credentials to be entered into the input prompt include gender, and height of the User.

13. The system according to claim 11, wherein the automatic instructions for the User to position the smart mobile device on the ground to capture six different body poses includes sequential audio instructions to pose in one of six different positions, each sequential audio instruction being provided after a photograph is automatically captured of a current pose.

14. The system according to claim 11, wherein errors in each of the six captured body poses are detected when the comparison between each of the captured body poses and each of the six stored pre-configured body pose positions is determined to be outside a preset error tolerance range.

15. The system according to claim 14, wherein the computer vision AI technology program will activate text-to-voice audio commands instructing the User as to which limb of the body to adjust in order to guide the User to the correct angle between the joints and then capture a corrected body pose.

16. The system according to claim 11, wherein the computer vision AI technology program will generate at least fourteen different body measurements for a male gender input and sixteen different body measurements for a female gender input.

17. The system according to claim 11, wherein an avatar is displayed that has interactive icons which enable a User to manually rotate and re-position the avatar's limbs, pelvis and upper body in various human-like poses, and then tap a numerical table to display the specific locations of at least fourteen body measurements on said avatar.

18. The system according to claim 11, wherein the computer program further displays an icon that enables the User to export the avatar together with the table of at least fourteen different body measurements via email, print and message via a messaging app.

19. The system according to claim 11, wherein an algorithm applies the User's at least fourteen different body measurements to display an avatar that has a body shape which best represents that of the User, selecting from industry standard body shapes that are used by the garment industry, as well as allowing the User to override the algorithm's body shape recommendation.

20. The system according to claim 11, wherein Augmented Reality (AR) software embedded in a User's device generates a 3D avatar in augmented reality that is manually manipulatable for overall size and joints, is moveable to any position, is moveable to 360 degrees, is manipulatable to view the location of at least fourteen body measurements on the avatar, and is exportable along with its augmented reality environment via email, print, a messaging app, accompanied by the User's body measurement table.
